(19) United States
(12) Patent Application Publication
(10) Pub. No.: US 2007/0056410 A1
(43) Pub. Date: Mar. 15, 2007

(54) Bolt Tamer

(76) Inventor: Lucas Jeffery Starr, Council Bluffs, IA (US)

Correspondence Address: Lucas Starr, 120 Kenmore Ave., Council Bluffs, IA, 51503, US

(21) Appl. No.: 11/221,692

(22) Filed: Sep. 9, 2005

(51) Int. Cl. B25B 13/00; B25B 7/02

(52) U.S. Cl. 81/124.3; 81/415; 81/418

(57) ABSTRACT

A hand tool comprising a first arm, further comprising a first handle, a first plate-like body coupled to the handle, a first jaw coupled to the first plate-like body and a second arm pivotally coupled to the first arm, the second arm further comprising a second handle, a second plate-like body coupled to the handle, and a second jaw coupled to the second plate-like body. The first arm and the second arm further comprise a first channel and a second channel forming a negative space when the first arm and the second arm are coupled together suitable for receiving an elongated member inserted lengthwise through the hand tool through the negative space.

### FIELD OF THE INVENTION

This invention relates to slip joint, box joint and ratchet's extender accessory which allows these tools to maintain a proper grip on the nut as it moves down the bolt allowing the bolt itself to pass through the tool.

### BACKGROUND OF THE INVENTION

Conventional slip joint tools, and box joint tools can only tighten a nut to a certain distance down a bolt until the bolt runs into the tool, therefore preventing further tightening and also forcing the user to use a less proper grip at an angle instead of a proper grip straight on. Additionally, these tools force a user to switch to other tools when attempting to find the correct tool to use for tightening a nut onto a bolt. All current existing utility, and functions force the user to tighten the nut at an awkward angle, which leads to rounding of the nut from an un-ideal grip. Additionally, in a confined space the tool is only allowed to rotate the nut only a few degrees increasing work time and labor.

Currently ratchet extender accessories are solid and when tightening a nut down a bolt, the bolt reaches up and hits the extender preventing the ratchet from further tightening the nut down the bolt, thus forcing the user to change to a less suitable tool.

Consequently, it would be advantageous if an apparatus existed that maintained a grip on a nut as the nut travels down a bolt.

### SUMMARY OF THE INVENTION

Accordingly, the various embodiments of the present invention are directed to hand tool formed to maintain a grip on the nut as the nut travels down a bolt. The hand tool may be a slip joint tool, box joint tool, a ratchet extender accessory or a like tool or accessory suitable for engagement with a fastening device such as a nut and a companion fastening device such as a bolt. Hand tool may be formed with a negative space or void within the tool to allow a bolt or similar object to pass through the center of the tool, thereby creating a new function for the tool, improving upon the tool's ease of use and adding a new utility to these tools.

According to an embodiment of the present invention, hand tool may be a slip joint tool. Slip joint tool may comprise at least two elongated members pivotally interconnected by a pivot joint to provide a pair of handles and a pair of jaw carrying members. The pivotable jaws may have flat planar surfaces opposing one another, and the handles include an adjustable pivotable connection to enable the hand tool to engage a plurality of different sized fasteners. Each angle-shaped jaw may be configured to engage two sides of a hexagonal fastener, and the pivot joint may be configured as a slip joint. Slip joint tool may be formed with a channel forming a negative space or void within the tool to allow a bolt or similar object to pass through the center of the tool.

According to an additional embodiment of the present invention, hand tool may be a box joint tool. Box joint tool may be formed with a channel forming a negative space or void within the tool to allow a bolt or similar object to pass through the center of the tool.

According to a further additional embodiment of the invention, apparatus may be a ratchet extender accessory. Ratchet extender accessory may be formed with a channel forming a negative space or void within the tool to allow a bolt or similar object to pass through the center of the tool.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a side elevation view of a hand tool according to and embodiment of the present invention having a slip joint;

FIG. 2A is a side elevation view of a right arm of a hand tool according to an embodiment of the present invention having a slip joint;

FIG. 2B is a perspective view of a right arm of a hand tool according to an embodiment of the present invention having a slip joint;

FIG. 3A is a side elevation view of a left arm of a hand tool according to an embodiment of the present invention having a slip joint;

FIG. 3B is a perspective view of a left arm of a hand tool in accordance with an embodiment of the present invention;

FIG. 4 is a front view of both arms of a hand tool coupled together in the open position in accordance with an embodiment of the present invention;

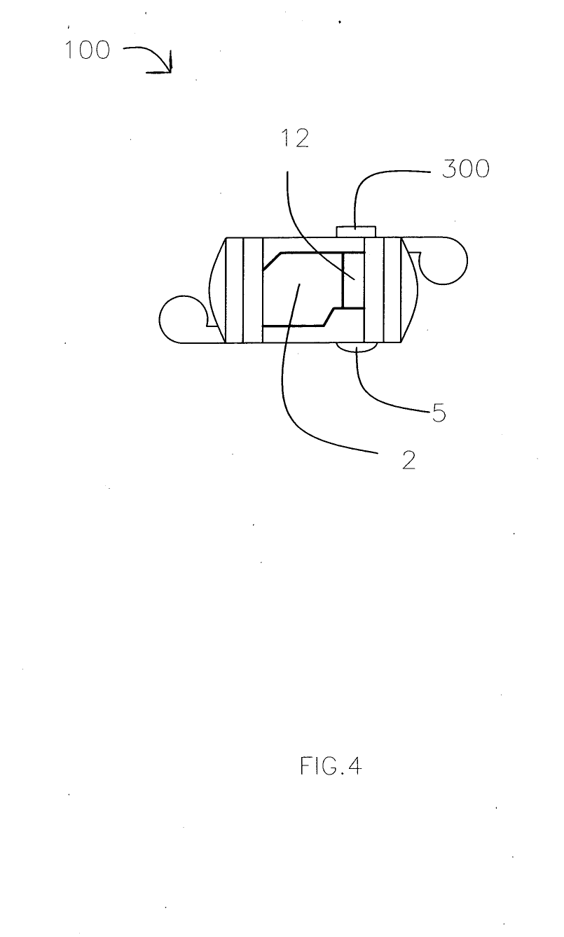

FIG. 5 is a side view of a pin or bolt suitable for engagement with a hand tool in accordance with an embodiment of the present invention;

FIG. 6 is a top view of a pin or bolt suitable for engagement with a hand tool in accordance with an embodiment of the present invention;

FIG. 7 is a perspective view of a pin or bolt suitable for engagement with a hand tool in accordance with an embodiment of the present invention;

FIG. 8 is a top view of a nut suitable for engagement with a pin or bolt in accordance with an embodiment of the present invention;

FIG. 9 is a side view of a nut suitable for engagement with a pin or bolt in accordance with an embodiment of the present invention;

FIG. 10 is a perspective view of a nut suitable for engagement with a pin or bolt in accordance with an embodiment of the present invention;

FIG. 11 is a top view of two arms of a hand tool according to an additional embodiment of the present invention coupled together in a open position with a bolt going through the void or negative space;

FIG. 12 is a front view of a hand tool according to an additional embodiment of the present invention in the open position;

FIG. 13 is top view of a first arm of the hand tool of FIGS. 11 and 12 in accordance with embodiment of the present invention;

FIG. 14 is a perspective view of the first arm of the hand tool of FIGS. 11 and 12 in accordance with an embodiment of the present invention;

FIG. 15 is top view of a second arm of the hand tool of FIGS. 11 and 12 in accordance with an embodiment of the present invention;

FIG. 16 is a perspective view of the second arm of the hand tool of FIGS. 11 and 12 in accordance with an embodiment of the present invention;

FIG. 17 is a side view of a ratchet extender accessory that may be implemented with a hand tool in accordance with an embodiment of the present invention;

FIG. 18 is a perspective view of a ratchet extender accessory in accordance with an embodiment of the present invention; and

FIG. 19 is a top view of a ratchet extender accessory in accordance with an embodiment of the present invention.

### DETAILED DESCRIPTION OF THE INVENTION

Reference will now be made in detail to the presently preferred embodiments of the invention, examples of which are illustrated in the accompanying drawings.

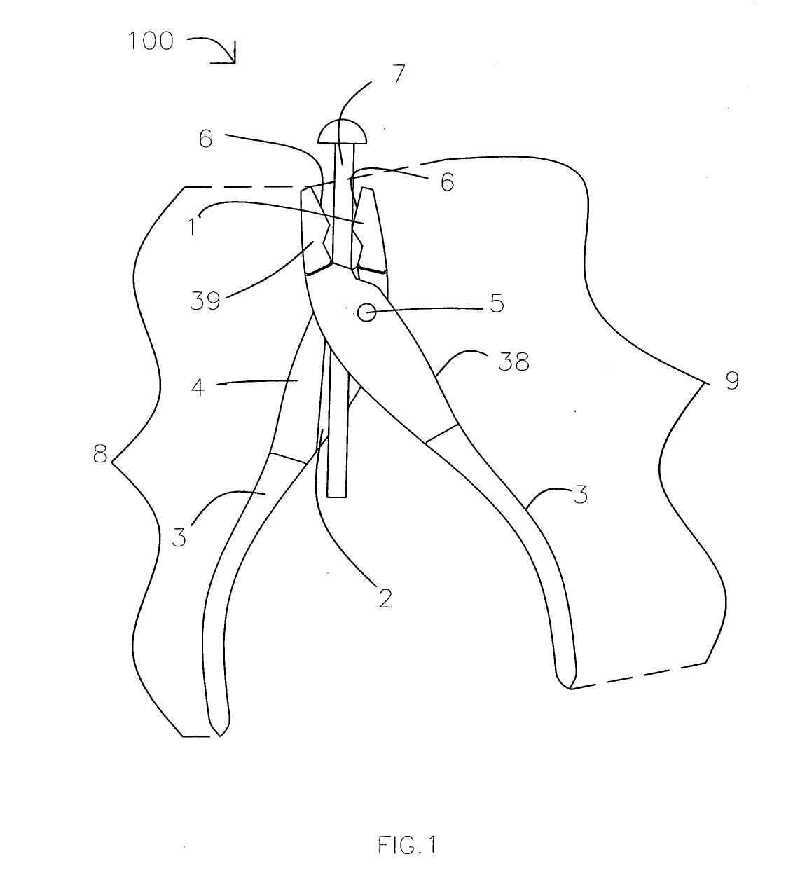

Referring to FIGS. 1, 2A, 2B, 3A and 3B views of a first embodiment of the hand tool 100 according to the invention is shown. In this embodiment, hand tool 100 is depicted as slip joint pliers. Referring specifically to FIG. 1, a side elevation view of a hand tool 100 according to and embodiment of the present invention having a slip joint is shown. The hand tool 100 may be formed from a first elongated member, or first arm 8 including a handle 3, a first plate-like body 4 and a jaw 1. A second elongated member, or second arm 9 may comprise a handle 3, a second plate-like body 38, and a jaw 39. The jaws 39, 1 may be offset with respect to the first and second plate-like bodies 38, 4 to which they are connected at portions respectively, to permit the outer ends of the jaws 39, 1 to directly oppose one another. The first arm 8 and the second arm 9 further comprise a first channel 2 and a second channel 42 forming a negative space suitable for receiving an elongated member inserted lengthwise through the hand tool through the negative space. The first and second plate-like body portions 38, 4 may be pivotally interconnected by a slip joint provided by adjusting notches formed in the second plate-like body 38 and a pin 5 connected to the first plate-like body 4 of the first arm 8. The pin 5 may extend through the adjusting notches in a conventional manner to allow multi-position adjustability of the slip joint pliers. The jaw 39 of the second arm may be configured to provide a recess to accommodate pivotal movement of the jaw 39, and the jaw 1 of the first arm may be configured to provide a recess to accommodate the pivoting movement of the 1 jaw. It is further contemplated that jaws 39, 1 may comprise teeth 6 formed substantially on a surface of the jaws 39, 1 that may be in contact with a bolt, screw, or like fastening device. Teeth 6, may provide friction between the jaws 39, 1 and a fastening device manipulated by the hand tool 100.

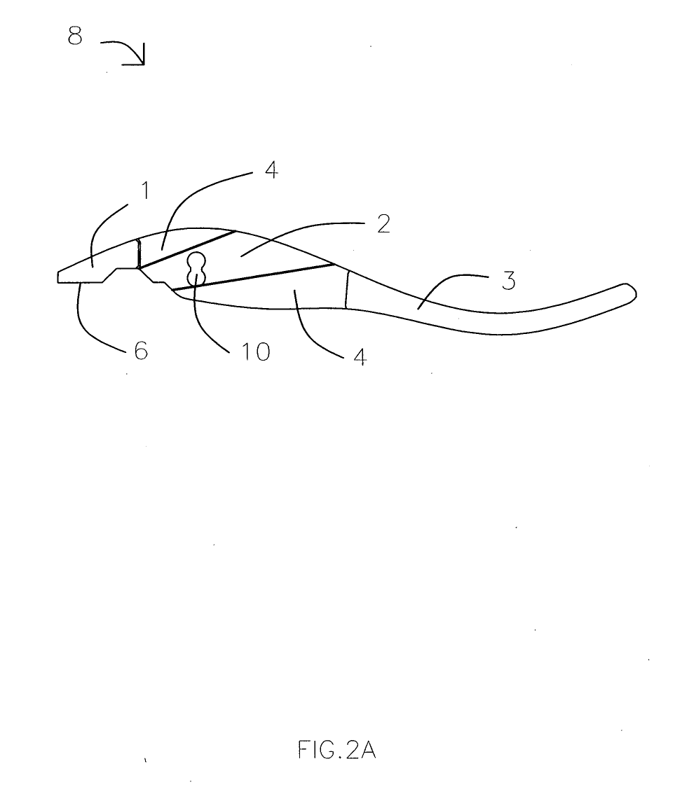

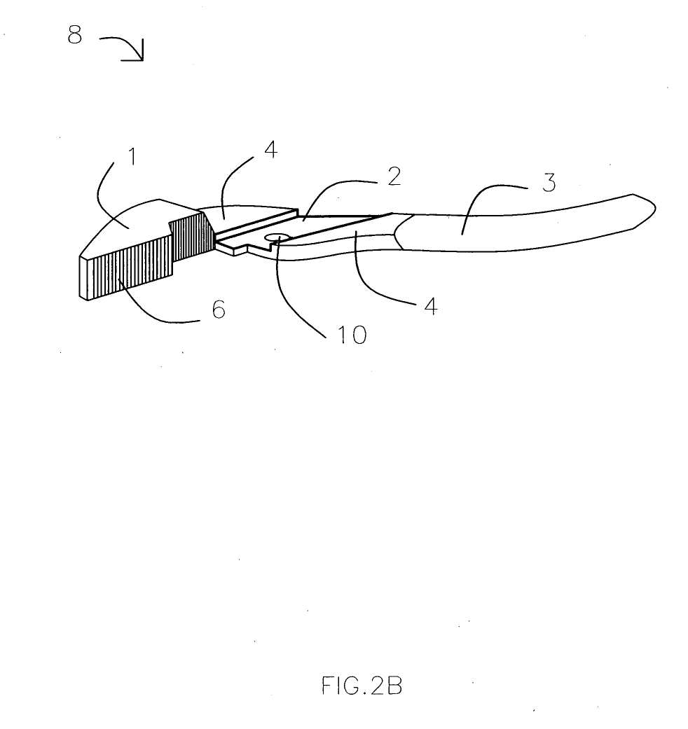

Referring to FIGS. 2A and 2B, first arm 8 may comprise a first channel 2 created by removing material from the first arm 8. First channel 2 may be formed via the creation process of the hand tool mold by removing less material during its creation, while maintaining the current manufacturing process of drop forging, or like manufacturing of the hand tool 100 after the mold is milled out. In the case of pliers there may be two molds, one for the first arm 8 and one for the second arm 9, as they are may not be identical.

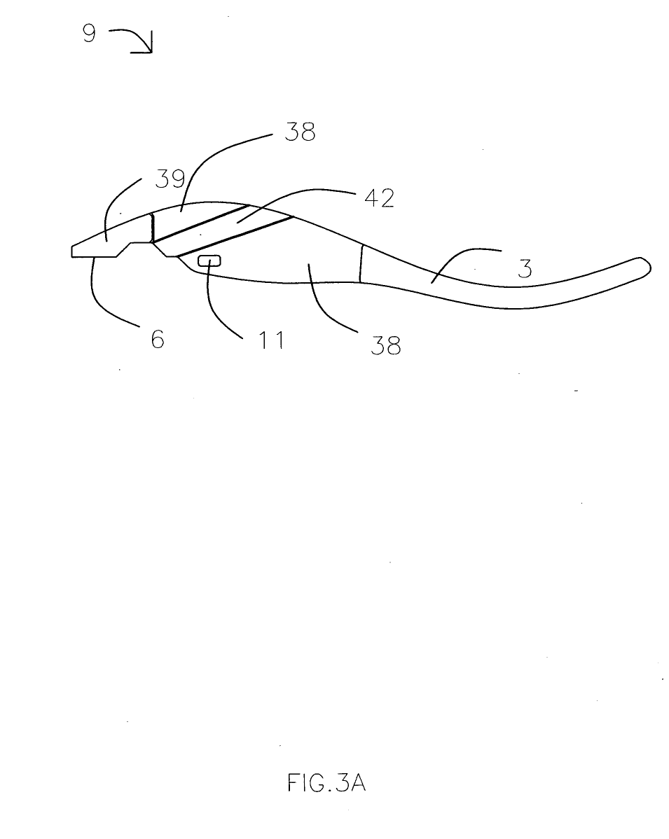

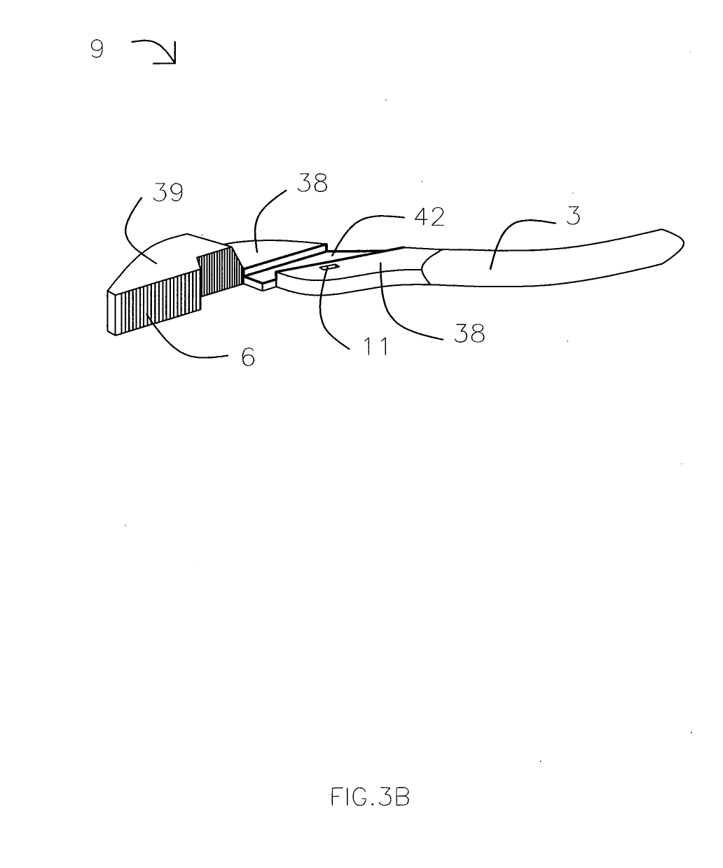

Likewise, referring to FIGS. 3A and 3B, second arm 9 may comprise a second channel 42 created by removing material from the second arm 9. Second channel 42 may be formed via the creation process of the hand tool mold by removing less material during its creation, while maintaining the current manufacturing process of drop forging, or like manufacturing of the hand tool 100 after the mold is milled out. Second channel 42 may be smaller in width than first channel 2 as the arms 8, 9 are parallel to one another. However, the depth of the second channel 42 may be equivalent to the depth of the first channel 2.

First arm 8 may comprise a elevated portions 4 disposed substantially above and below channel 2. Second arm 9 may similarly comprise elevated portions 38 disposed substantially above and below channel 42. Elevated portions 4, 38 may demonstrate the normal thickness of the tool 100. The reduction in material created by the channels 2, 42 may have a depth of a approximately 1/16 inch. Yet the hand tool thickness in the channel 2, 42 remains sufficient as to not compromise the tool's structural integrity. Another part of the hand tool arms is the jaw section. Jaws 1, 39 may be the thickest part of the tool, and may further comprise teeth 6. Hand tool arms 8, 9 may further comprise a handles 3 coupled to a plate-like body portions 4, 38. Handles 3 may be attached, extend out and maintain the thickness on the Z axis while getting thinner on the Y axis, and bending along the X axis to create a handle 3. Handles 3 may be dipped to create a rubber handle for increased grip after it has been assembled to the first and second arms 8, 9.

Referring to FIG. 2A, the first arm 8 may comprise an aperture 10 for the pin or bolt 200 to be inserted through. For instance, the first arm 8 may be provided with a slip joint 10 for the pin or bolt 200 to move. The slip joint 10 may be formed during the molding process, where two circular holes are created having the same diameter, and connected to each other by a smaller rectangular section.

The slip joint 10 may be placed inside the channel 2. The depth of the channel 2 matches the depth of the channel 42 of the second arm 9, but the sides of the removed material are not parallel. Rather the sides may be at offset angles so that the channel 2 gets wider towards the handle 3 and smaller towards the jaw 1. On the first arm 8, the jaw section 1, teeth 6, and handle 3 are created exactly the same as the second arm, because these sections of the molds are the same forms, and milled out just the same.

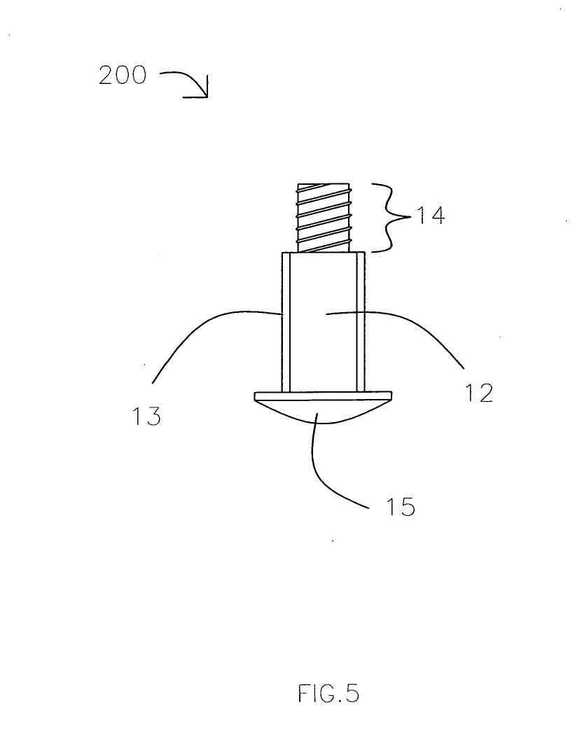

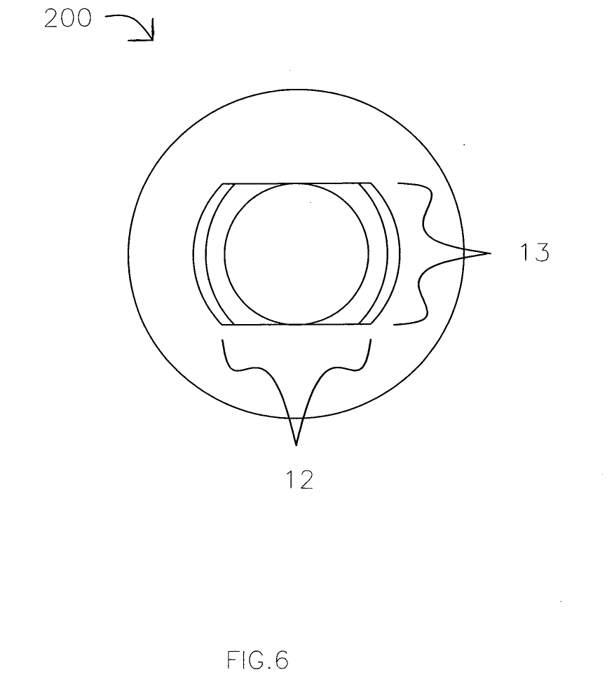

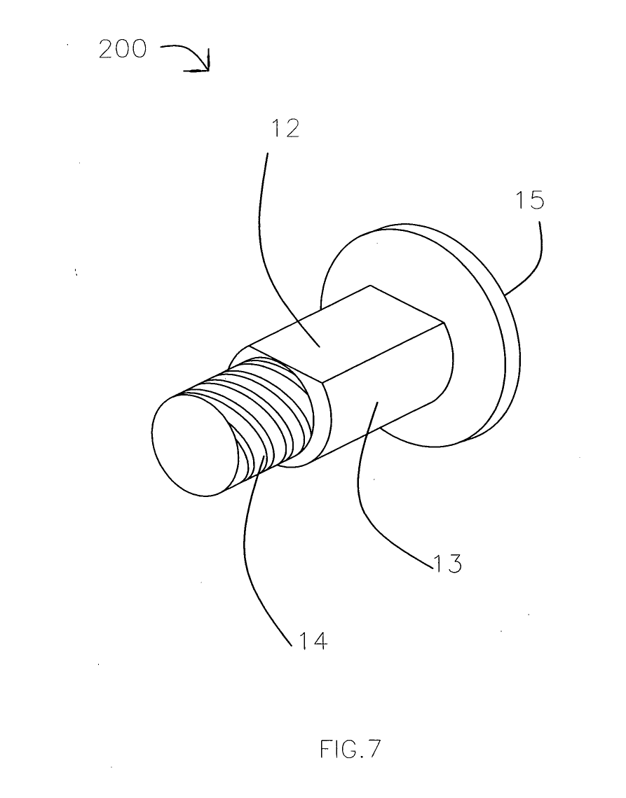

Referring generally to FIGS. 5-7, views of a pin or bolt 200 suitable for fastening the left arm 8 and right arm 9 are shown. In one embodiment, pin or bolt 200 may be put in place by the form of the mold. Referring specifically to FIG. 5, a side view of a pin or bolt suitable for fastening the arms of a hand tool in accordance with an embodiment of the present invention is shown. Referring specifically to FIG. 6, a top view of a pin or bolt 200 suitable for fastening the arms of a hand tool in accordance with an embodiment of the present invention is shown. Referring specifically to FIG. 7, a perspective view of a pin or bolt 200 suitable for fastening the arms of a hand tool in accordance with an embodiment of the present invention is shown. The pin or bolt 200 may comprise a pin body further comprising at least two opposite substantially flat surfaces 12, at least two opposite substantially rounded surfaces 13, and a head section 15. The flat surface 12 allows the pin or bolt 200 to travel from one circular section of the slip joint 10 to the other, and also lock into a desired position. The flat surfaces 12 are to allow this pin or bolt 200 to slip through the smaller rectangular section of the slip joint 10, where the rounded sides allows the pin or bolt 200 to rotate in the circular sections of the slip joint 10. This pin or bolt 200 has a head 15 suitable for assisting the securing of the pin or bolt 200 in place, along with a nut 300 and the mating hole 11 on the second arm. The manufacturing process of the this pin or bolt 200 may be through a two part mold, in which the mold can be long as to produce multiple pins or bolts 200 simultaneously.

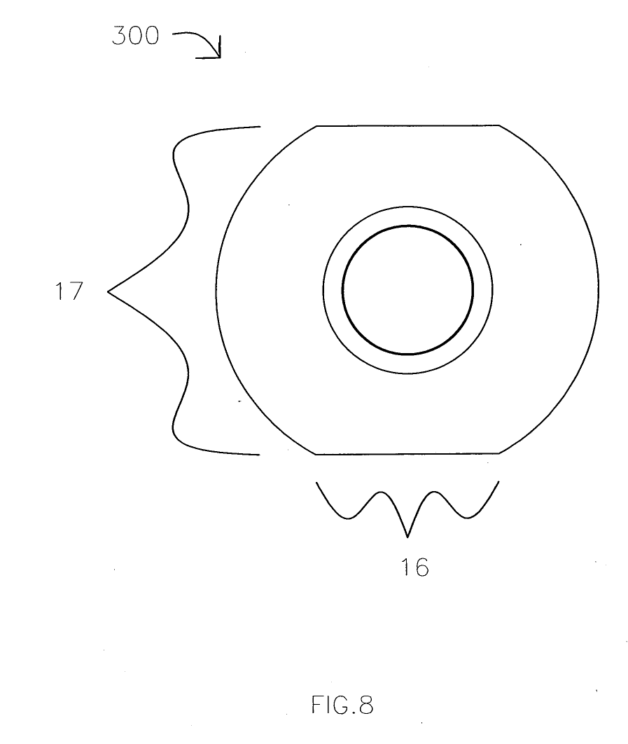

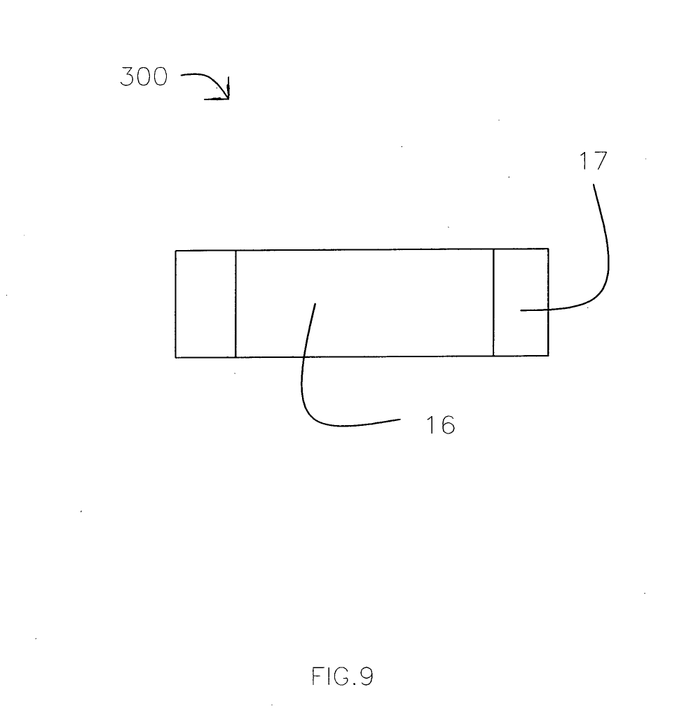

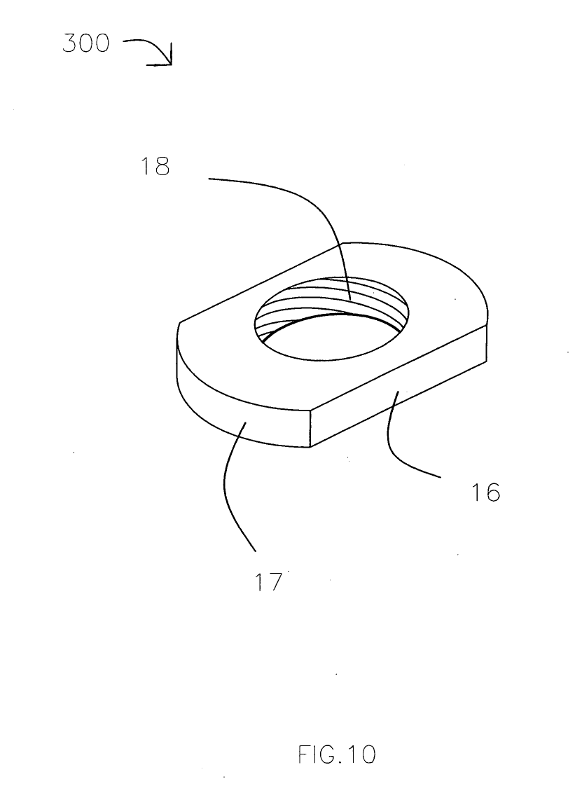

A portion of the pin or bolt 200 may be threaded to engage a nut 300, such as the nut 300 illustrated in FIGS. 8-10. Once both arms 8, 9 are drop forged, they may be fastened together by a pin or bolt 200, and a nut. Referring specifically to FIG. 8, a top view of a nut 300 suitable for engagement with a pin or bolt 200 in accordance with an embodiment of the present invention is shown. Referring specifically to FIG. 9, a side view of a nut 300 suitable for engagement with a pin or bolt 200 in accordance with an embodiment of the present invention is shown. Referring specifically to FIG. 10, a perspective view of a nut 300 suitable for engagement with a pin or bolt 200 in accordance with an embodiment of the present invention is shown. The nut 300 may comprise at least two flat edges 16 and at least two rounded edges 17. Flat edge 16 and rounded edge 17 may allow secure engagement of the nut 300 with the pin or bolt 200. The nut 300 may also comprise matching threads 18 suitable for engagement with the pin or bolt 200.

After each component of the hand tool 100 has been made the tool can be assembled as illustrated in FIG. 1. Once assembled, the handles 3 may be covered in rubber by dipping them into a vat of liquid rubber.

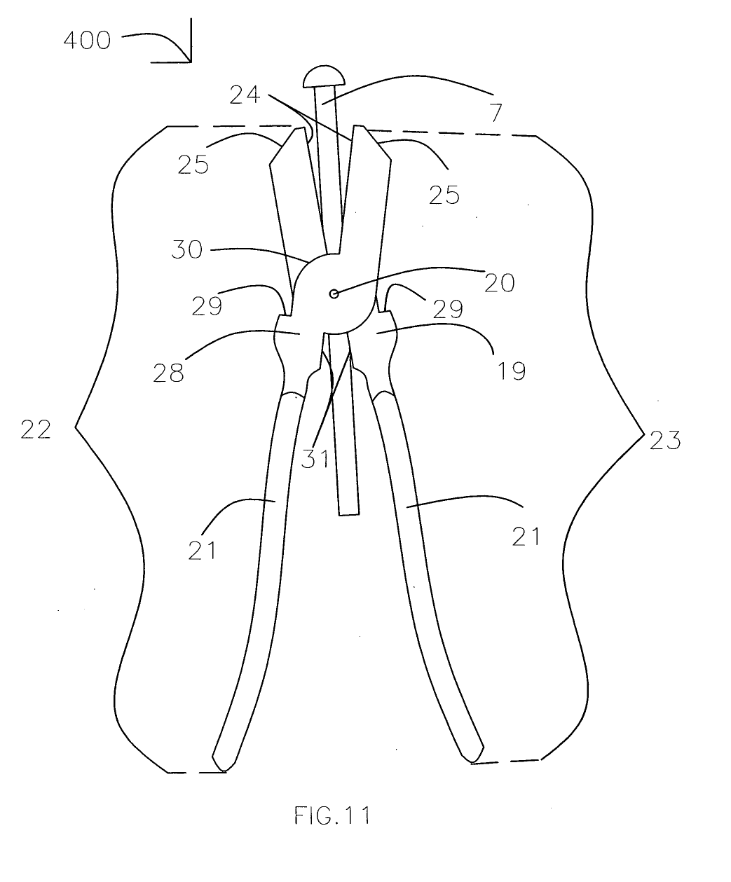

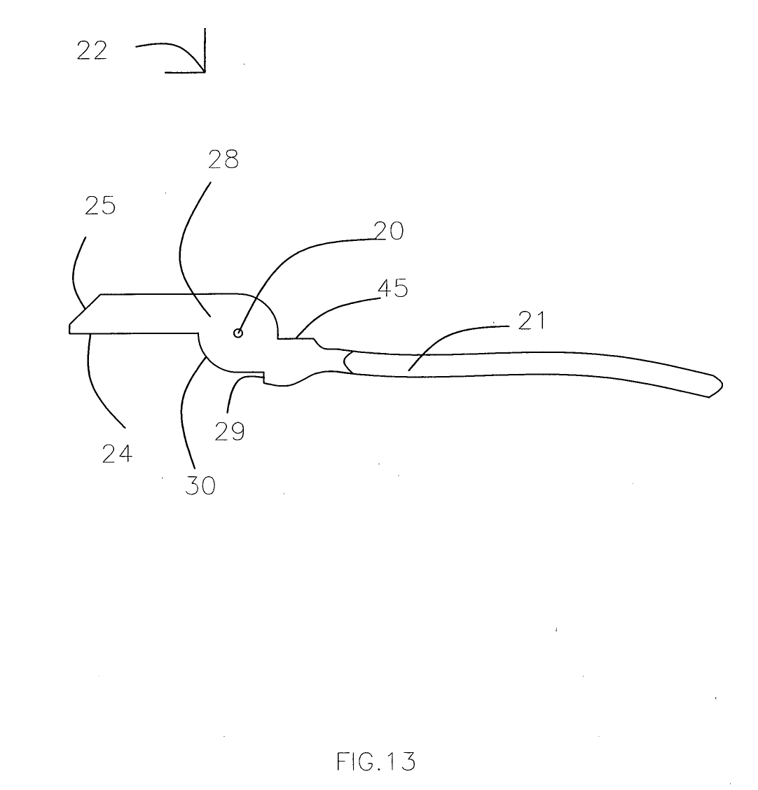

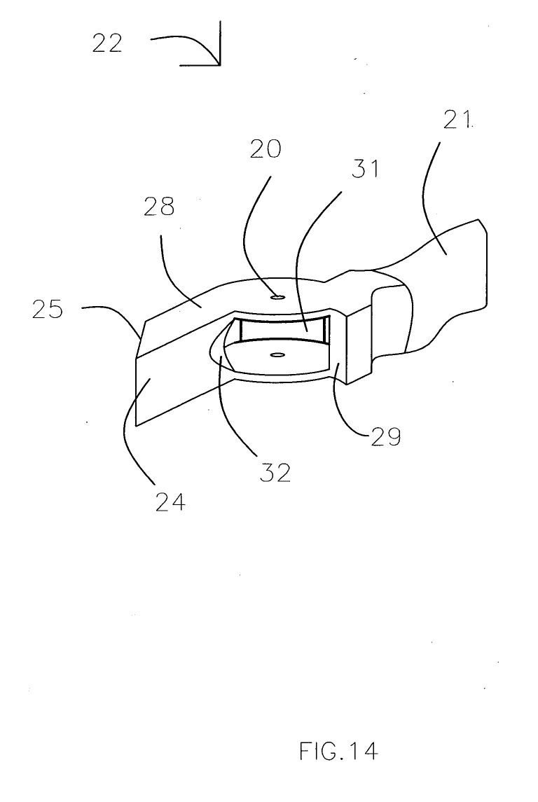

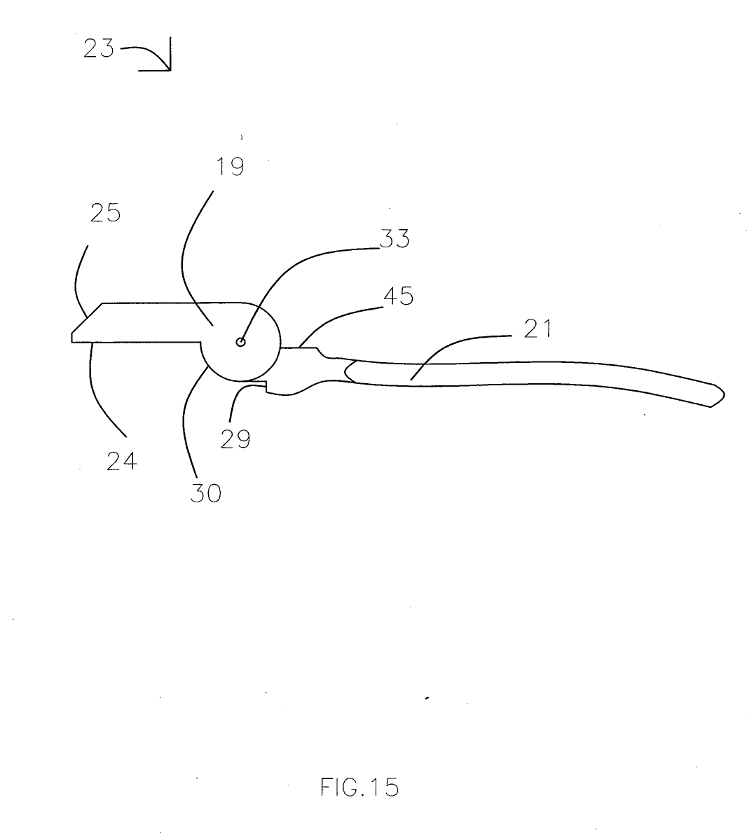

Referring to FIGS. 11-16, an additional embodiment of a hand tool 400 according to the present invention is shown. Hand tool 400 may be a box joint tool. Referring specifically to FIG. 11, a top view of two arms 22, 23 of a hand tool 400 according to an additional embodiment of the present invention coupled together in a open position with a bolt going through the void or negative space. Hand tool may comprise a first arm 22 pivotally coupled to a second arm 23. First arm may comprise a handle 21, a head 28, a stop 29, and a hinge. Second arm may comprise a handle 21, a head 19 a stop 29 and a hinge 31 the first arm and the second arm further comprise a first channel and a second channel forming a negative space 31 when the first arm and the second arm are coupled together suitable for receiving an elongated member inserted lengthwise through the hand tool through the negative space.

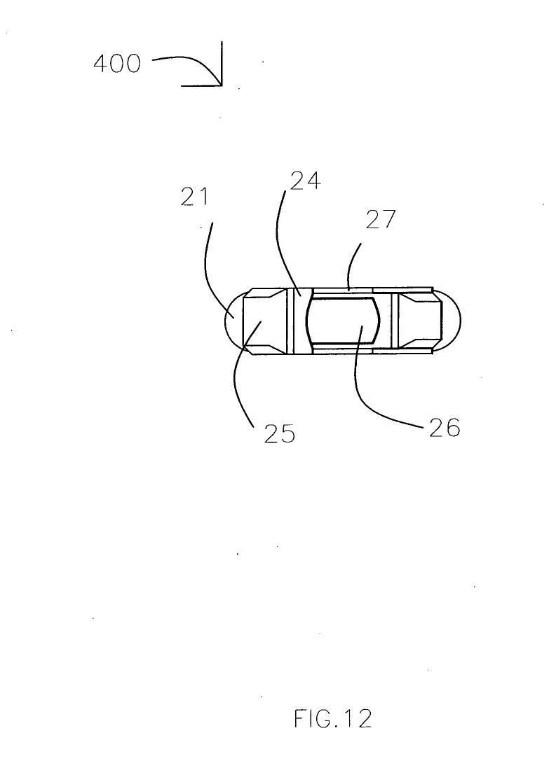

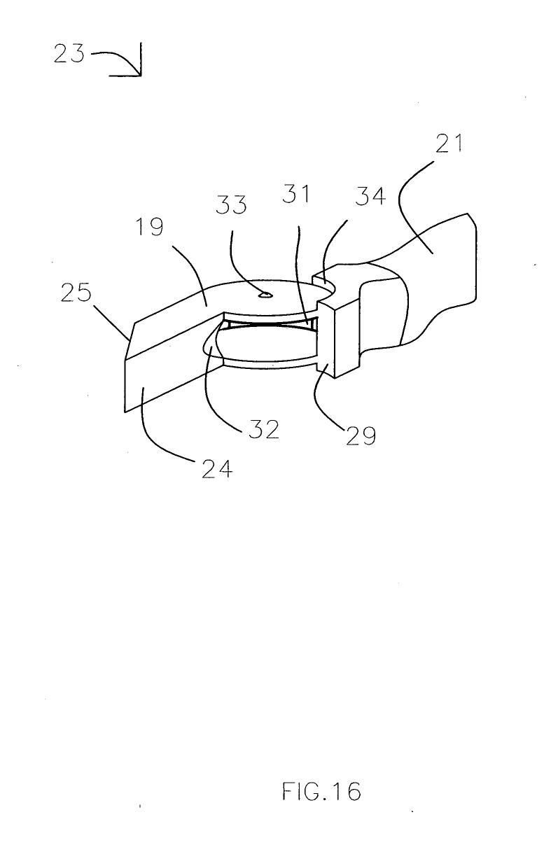

In the case of box joint tools a void and or negative space 31 may be created by changing the box joint tool from three pieces to two pieces, instead of a pin connecting and holding the two pieces together, the molds are changed so that the first and second arms 22, 23 not only comprise a head, handle, stop, and a channel but also the hinge that connects the two pieces by a pin. The first and second arms 22, 23 are both created by a two part mold which is then drop forged. The two molds are different, the head and hinge section are different thickness. The second arm may have a thinner head 19. Referring specifically to FIG. 16, a perspective view of the second arm 23 of the hand tool 400 of FIGS. 11 and 12 in accordance with an embodiment of the present invention is shown. The second arm 23 and head 19 may be thinner than the stop 29 and handle 21, and a ridge 34 may be formed from the variation in depth to allow the first and second arms 22, 23 to be assembled. The second arm 23 may comprise a small pin in the center of where the hinge is located. The first arm 22 may comprise a hole to register the pin from the second arm 23, which may allow the tool to rotate and hold the two arms 22, 23 together. Because this joint is formed in a two part mold, it allows a void and/or negative space 31 to be created which allows up to a quarter inch thick bolt or object to pass through the tool. On both the first and second arms 8, 9, the jaw has at the teeth 24 a negative curved surface to allow more tolerance for an object to pass through the void and/or negative space 31 when the tool is open.

Each arm 22, 23 of the hand tool 400 may also comprise a stop 29. Stops 29 may be flat sides that act as a stop when opening the tool 400, which limits the opening angle of the arms 22, 23. Extending long and curved to the rear is the handle 21 while matching thickness on both arms are the handles, however on the Y axis on the top view the handle is thinner than the rest of the tool. Once each piece is pulled out of the molds, they can be assembled as illustrated in FIG. 11, after which it will be dipped in liquid rubber to form the rubberized handles 21.

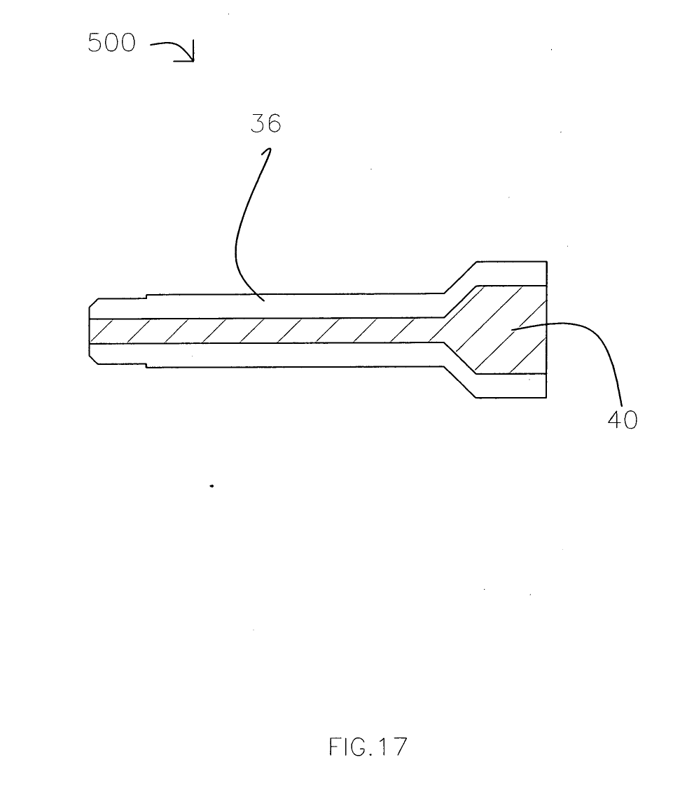

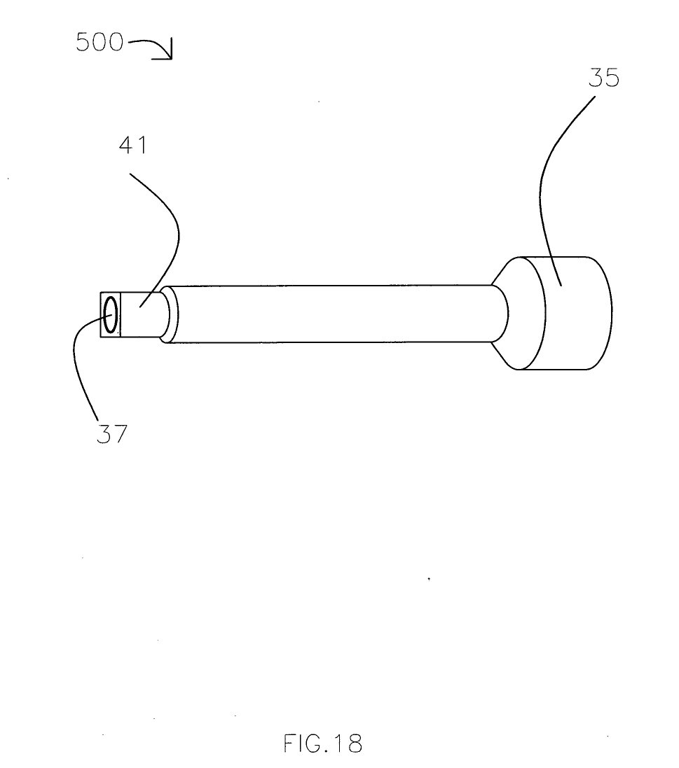

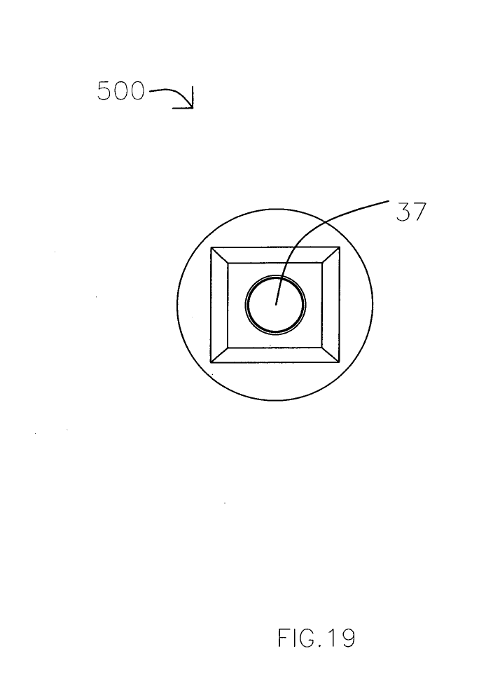

Referring to FIGS. 17-19, a ratchet extender accessory 500 in accordance with an embodiment of the present invention is shown. Referring specifically to FIG. 17, a side view of a ratchet extender accessory 500 that may be implemented with a hand tool in accordance with an embodiment of the present invention is shown. Referring specifically to FIG. 18, a perspective view of a ratchet extender accessory 500 in accordance with an embodiment of the present invention. Referring specifically to FIG. 19, a top view of a ratchet extender accessory 500 in accordance with an embodiment of the present invention is shown. The ratchet extender accessory 500 may be formed by a two part mold, in which the piece must be caste in the vertical position, and upside down so that the opening of the tool that will attach to the ratchet is up, and the attachment to the socket is downward. The two part mold must be pulled up in a vertical fashion, as the natural shape of the exterior and interior of the extender is excellent for pulling the vertical part out of the mold straight up with the proper draft already designed into the piece. A first end portion 35 of the ratchet extender accessory 500 may be expanded to meet the ratchet. A second end portion 41 may be smaller in diameter and comprise at least two flat lateral edges, such as is known generally for engagement with a socket. Referring to FIG. 17, a channel 40 may be formed running the entire length of the tool. The 36 of the ratchet extender accessory may be comprised of substantial material thickness as to not compromise the tool's integrity. After the casting is complete the piece may then be prepared to be anodized for nickel, and then anodized for chrome. The nickel anodization generally must occurs first because the properties of nickel are generally more suitable for adhesion to the metal of the casting material, and the nickel surface is then is sufficient to hold the anodized chrome. It is to be noted that the length and diameter of the channel 40 may vary in size, depending on the size of the extender as ratchet extender accessories come in a myriad of sizes ranging from half inch thickness to six inch thickness, and from four inch lengths to two foot lengths.

It is believed that the present invention and many of its attendant advantages will be understood by the foregoing description. It is also believed that it will be apparent that various changes may be made in size, materials, shape, form, function, manner of operation, assembly and use of the components thereof without departing from the scope and spirit of the invention or without sacrificing all of its material advantages. The form herein before described being merely an explanatory embodiment thereof. Further, it is contemplated that the specific order or hierarchy of steps in the method can be rearranged while remaining within the scope and spirit of the present invention. It is the intention of the following claims to encompass and include such changes.

1. (canceled)

2. A hand tool comprising:
a first arm, further comprising:
a first handle;
a first plate-like body coupled to the handle; and
a first jaw coupled to the first plate-like body; and
a second arm pivotally coupled to the first arm, the second arm further comprising:
a second handle;
a second plate-like body coupled to the handle; and
a second jaw coupled to the second plate-like body,
wherein the first arm and the second arm further comprise a first channel and a second channel forming a negative space when the first arm and the second arm are coupled together suitable for receiving an elongated member inserted lengthwise through the hand tool through the negative space.

3. The hand tool of claim 2, further comprising a pin suitable for insertion through the first plate-like body and the second plate-like body.

4. The hand tool of claim 3, wherein the first plate-like body and the second plate-like body further comprise an aperture suitable for receiving the pin.

5. The hand tool of claim 4, wherein the aperture is a slip joint.

6. The hand tool of claim 4, further comprising a nut suitable for securing the pin within the aperture.

7. The hand tool of claim 6, wherein the pin and the nut each comprise at least two flat opposite surfaces and at least two rounded opposite surfaces.

8. The hand tool of claim 2, wherein the second channel formed in the second plate-like body is narrower at an end in closest proximity to the second jaw and wider at an end in closest proximity to the second handle.

9. The hand tool of claim 2, wherein the first handle and the second handle are dipped in rubber.

10. A hand tool comprising:
a first arm, further comprising:
a first handle;
a first plate-like body coupled to the handle further comprising a stop suitable for limiting an opening angle of the hand tool; and
a first head coupled to the first plate-like body; and
a second arm pivotally coupled to the first arm, the second arm further comprising:
a second handle;
a second plate-like body coupled to the handle further comprising a stop suitable for limiting an opening angle of the hand tool; and
a second head coupled to the second plate-like body; and
a hinge suitable for pivotally coupling the first arm and the second arm, wherein the first arm and the second arm form a negative space when the first arm and the second arm are coupled together via the hinge suitable for receiving an elongated member inserted lengthwise through the hand tool through the negative space.

11. The hand tool of claim 10, further comprising a pin suitable for insertion through the first plate-like body and the second plate-like body.

12. The hand tool of claim 10, wherein the second head is thinner than the first head to accommodate the hinged interconnection of the first head and the second head.

13. The hand tool of claim 10, wherein the second head further comprises a ridge formed from the variation in depth of the second head relative to the first head.

14. The hand tool of claim 10, wherein the first head and the second had further comprise a negative curved surface to provide more tolerance for an object to pass through the negative space when the tool is in an open position.

15. The hand tool of claim 10, wherein the first handle and the second handle are dipped in rubber.

16. A method of manufacturing a hand tool comprising:
forming a first arm, the first arm comprising
a first handle;
a first plate-like body coupled to the handle; and
a first head coupled to the first plate-like body; and forming a second arm, the second arm further comprising:
a second handle;
a second plate-like body coupled to the handle; and
a second head coupled to the second plate-like body; and
pivotally coupling to the first arm and the second arm,
wherein the first arm and the second arm further comprise a first channel and a second channel forming a negative space when the first arm and the second arm are coupled together suitable for receiving an elongated member inserted lengthwise through the hand tool through the negative space.

17. The method of claim 16, further comprising forming a pin suitable for insertion through the first plate-like body and the second plate-like body.

18. The method of claim 16, further comprising forming a pin suitable for insertion through the first plate-like body and the second plate-like body.

19. The method of claim 16, further comprising dipping the first handle and the second handle in rubber.

20. The method of claim 16, further comprising forming the second head to be thinner than the first head to accommodate the coupling of the first arm and the second arm.

21. The method of claim 16, further comprising forming a ratchet extender accessory comprising a first end portion, a second end portion and a channel running the entire length of the ratchet extender accessory.
